(19) United States
(12) Patent Application Publication
(10) Pub. No.: US 2007/0130021 A1
(43) Pub. Date: Jun. 7, 2007

(54) Method of providing pet accessories and people accessories with decorative stones

(76) Inventor: Nela Nafisseh Kashfi, Los Angeles, CA (US)

Correspondence Address: Albert W. Davis Jr, 6037 W Robin Lane, Glendale, AZ, 85310, US

(21) Appl. No.: 11/543,504

(22) Filed: Oct. 5, 2006

Related U.S. Application Data
(60) Provisional application No. 60/742,281, filed on Dec. 6, 2005.

(51) Int. Cl. G06Q 30/00

(52) U.S. Cl. 705/26

(57) ABSTRACT

Pet owners and others buy accessories for their animals such as harnesses, leashes, collars and other pet items. The invention adds decorative stones or jewels to the items. The decorative stones are matched to a color or colors of the animal. The owner and others can also be provided with items that match the colors of the pet. The items can be sold over the internet from a website. The items are also available for wholesale or sale to retail stores from a restricted access portion of the website.

This application is a continuation-in-part of provisional patent application Ser. No. 60/742,281, filed on Dec. 6, 2005.

### BACKGROUND OF THE INVENTION

Pet owners and others buy accessories with decoration for their pet animals such as harnesses, leashes, collars and other pet items. People also buy items with decoration for themselves.

### BRIEF SUMMARY OF THE INVENTION

Pet owners and others buy accessories for their animals such as harnesses, leashes, collars and other pet items. The invention adds decorative stones or jewels to the items. The decorative stones are matched to a color or colors of the animal.

The owner and others can also be provided with items that match the colors of the pet. Personal items that match the pet can be items, such as, a key ring that matches a dog collar in material (leather) and stones. Other items can be items which match the person's wardrobe without matching the pet, such as, matching belts, key rings, jewelry, his and hers matching accessories, etc.

The items can be sold over the internet from a website. The items are also available for wholesale or sale to retail stores from a restricted access portion of the website.

### BRIEF DESCRIPTION OF THE DRAWINGS

FIG. 1 is a side view of the invention.

FIG. 2 is a bottom perspective view of the invention.

FIGS. 3A-D are top views of the invention.

### DETAILED DESCRIPTION OF THE INVENTION

The invention is a method of doing business by providing pet accessories and matching people accessories. The pet industry is a large industry, and pet accessories will be a part of the future of the industry.

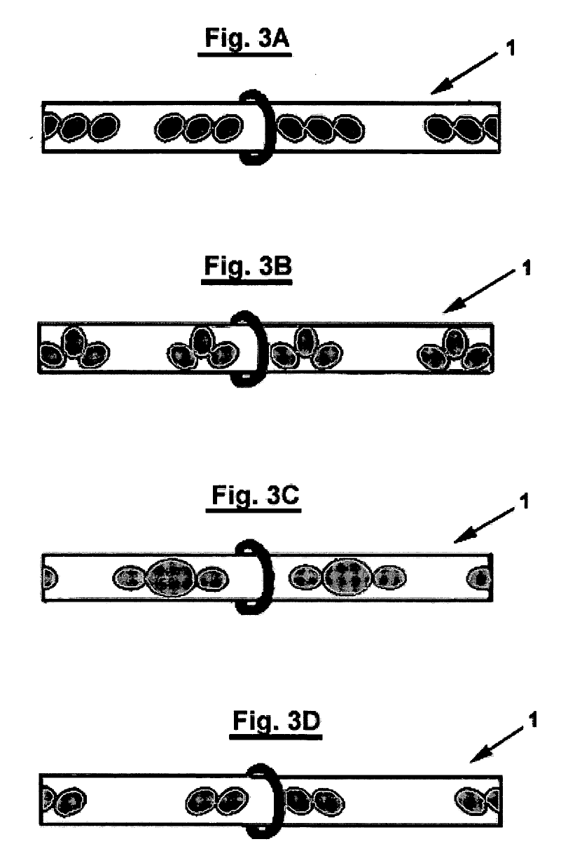

For example, the invention contemplates a pet accessory, such as a collar, harness, lead or other accessory, can be decorated by providing decorative stones 10 on the accessory. The stones will be arranged in patterns on the collar or other accessory. There can be several patterns to pick from as shown in FIGS. 3A-D.

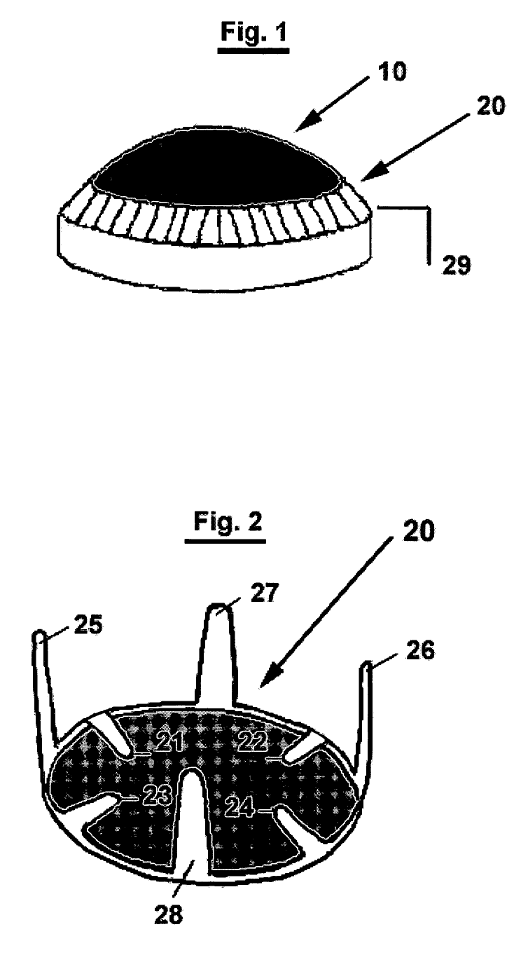

As shown in FIG. 1, the decorative stones 10 are large, such as an oval of 25×18 mm or an oval of 18×13 mm. The stone 10 is held in place on the collar by a metal rim 20. The stones can be precious, semi-precious or faux (plastic, such as Acrylic). For example, the rim can be made from metal brass sheets of 20 gauge by using a steel die in a stamping process. But, the preferred method is to cast the rim of brass. The brass is provided with a gold, antique brass or other finish finish. After the rim 20 is cast, it is polished to smooth the surfaces. Then, the rim can be plated with gold of 18 carats. Finally, the rim 20 is provided with a protective coating, such as a lacquer or other coating applied by electrophoretic deposition (EPD).

FIG. 2 shows the rim 20 with the stone 10 held in place by short prongs 21-24. Longer prongs 25-28 are used to attach the rim and stone assembly to the accessory 1. Four slits are cut in the accessory 1, and the longer prongs 25-28 are inserted through the slits and bent to secure the rim and stone assembly to the accessory. For example on the rim for the 25×18 mm oval stone, the short prongs 21-24 are 6 mm long, the long prongs 25, 26 are 14 mm long and long prongs 27, 28 are 12 mm long. The width of all of the long prongs is 3.5 mm at the base and 3 mm at the tip. For example on the rim for the 18×13 mm oval stone, the short prongs 21-24 are 5 mm long, the long prongs 25, 26 are 10 mm long and long prongs 27, 28 are 10 mm long. The width of all of the long prongs is 3 mm at the base and 2 mm at the tip. The thickness of all of the prongs is 2 mm. The width of both of the rims is 2 mm. The top portion 29 of the rim has an angle of 45 degrees. FIGS. 2, 3 are proportionally true to the dimensions in the example. The decorative ridges are cast into the top portion 29 of the rim.

The business will provide decorative pet accessories for cats, dogs and other pets (horses, etc.). The stones 10 will be matched to the colors or one color of the pet. The pet accessories can be collars, leads, harnesses, pet carriers, blankets, etc.

The business will also provide decorative accessories and jewelry for people. The accessories and jewelry will match that of the pet and can be selected at the same time as the purchase of the pet accessory.

The matching decorative people accessories that will be available include key rings, bookmarks, paperweights, wall magnets, belts, jewelry of leather or other material, travel and other use bags, walking waist bags, handbags, leather or other material straps for various uses, leather or other material jackets and shirts, hats or caps of cloth or leather, and other types of clothing.

The jewelry will be bracelets, necklaces, rings, etc using the same color stones as at least some of the stones used in the pet accessories.

The people items can match the persons wardrobe without matching the pet items. For example, people items, such as belts, key rings, jewelry, etc., can have stones and or material that match a color of a wardrobe or match each other.

The predominant shape of the stones is oval; however other shapes, such as circular, diamond, rectangular, etc., are possible. The stones can be all one color, multicolored or marbleized. The faux stones can be cast Acrylic plastic. The rim molds are dimensioned to match the faux stones. The semi-precious stones are cut to match the rims.

For example, the matching color for a black and white terrier can be black leather with white stones. The matching color for a solid brown poodle can be crème leather with brown stones.

FIGS. 3A-D show several of the patterns for the stones in their settings. The pet accessory 1 is a collar in these views. More patterns can be provided. The use of different shaped stones together is also contemplated.

Various changes and modifications to the embodiments herein chosen for purposes of illustration will readily occur to those skilled in the art. To the extent that such modifications and variations do not depart from the spirit of the invention, they are intended to be included within the scope thereof which is assessed only by a fair interpretation of the following claims.

I claim:

1. A method of providing pet accessories to a retail customer comprising the steps of,
providing a website having information on how to order the pet accessories,
the website having various pet accessories, having decorative stone and rim assemblies shown in color, and having patterns for the stone and rim assemblies,
allowing the retail customer to select, from the accessories shown, the pet accessory, the type of decorative stone and rim and the design of the accessory which encompasses the color of the material and the color and pattern of the stone and rim assembly and
allowing the retail customer to place an order for the accessory through the website and
shipping the accessory directly to the customer.

2. The method of claim 1, including the steps of,
providing people accessories at the website that match the accessories of the pet.

3. A method of providing pet accessories to a wholesale customer for resale, comprising the steps of,
providing a website having information on how to order the pet accessories,
the website having various pet accessories, having decorative stone and rim assemblies shown in color, and having patterns for the stone and rim assemblies,
allowing the wholesale customer to select, from the accessories shown, the pet accessory, the type of decorative stone and rim and the design of the accessory which encompasses the color of the material and the color and pattern of the stone and rim assembly and
allowing the wholesale customer to place an order for the accessory through the website and
shipping the accessory directly to the wholesale customer.

4. The method of claim 3, including the steps of,
providing people accessories at the website that match the accessories of the pet.

5. A method of providing pet accessories to a wholesale customer for resale, comprising the steps of,
providing a website having information on how to order the pet accessories,
the website having various pet accessories, having decorative stone and rim assemblies shown in color, and having patterns for the stone and rim assemblies,
allowing the wholesale customer to select, from the accessories shown, the pet accessory, the type of decorative stone and rim and the design of the accessory which encompasses the color of the material and the color and pattern of the stone and rim assembly and
allowing the wholesale customer to place an order for the accessory through the website and
shipping the accessory directly to a retail customer of the wholesale customer.

6. The method of claim 5, including the steps of,
providing people accessories at the website that match the accessories of the pet.
